(19) United States
(12) Patent Application Publication
(10) Pub. No.: US 2015/0360220 A1
(43) Pub. Date: Dec. 17, 2015

(54) CELL CULTURE SCRAPING DEVICE

(71) Applicant: Rutgers, The State University of New Jersey, New Brunswick, NJ (US)

(72) Inventors: Rick Cohen, New Brunswick, NJ (US); Rick Anderson, New Brunswick, NJ (US); Ali Hashemi, Randolph, NJ (US)

(21) Appl. No.: 14/736,671

(22) Filed: Jun. 11, 2015

Related U.S. Application Data
(60) Provisional application No. 62/011,255, filed on Jun. 12, 2014.

(51) Int. Cl. B01L 3/18

(52) U.S. Cl. CPC B01L 3/18; B01L 2200/028; B01L 2200/087; B01L 2200/12; B01L 2300/0848; B01L 2300/123; B01L 2300/12; B33Y 10/00

(57) ABSTRACT

A device for scraping cells and tissues and methods of fabricating the same are disclosed herein.

### CROSS-REFERENCE TO RELATED APPLICATIONS

This application claims the benefit of priority to U.S. Provisional Application No. 62/011,255, filed Jun. 12, 2014, the entire content of which is incorporated herein by reference.

### FIELD OF THE INVENTION

The present invention relates generally to a cell culture instrument and more particularly, but not exclusively, to a cell culture scraping device for adjusting cells disposed on a surface.

### BACKGROUND OF THE INVENTION

Laboratory procedures known in the field often require the cultivation and management of tissues or cells for analysis and diagnostic testing. In many cases, cells are grown on the surface of a medium in a dish. While these cells and tissues grow upon the medium they may require removal or modification. In order to move, remove, or otherwise modify the cells and tissues in the dish, a scraper or other implement may be required to select, or dislodge the cells and tissues from the medium. Often, the cells and tissues are grown on a small scale, such as the millimeter or sub-millimeter scale, requiring the use of fine instruments.

Currently, stem cell scientists “clean” or “pick” stem cells, for example, from non-homogenous cultures using laboratory generated devices derived from flaming/melting borosilicate glass Pasteur pipettes with a high-temperature natural gas powered Bunsen burner. While this technique is a standard laboratory practice, by virtue of the method, it produces a scraper that has a non-standardized shape and geometry, making the techniques used therewith difficult to teach and master. Additionally, this often requires the preparation of many scrapers that require autoclaving, are prone to breaking, require the user to use a natural gas burner, and stand over an open flame during their preparation.

Accordingly, there is a need in the field for cell culture scrapers that work on the scales necessary for tissue and cell cultures, which have some limited reusable components and allow for customization or modification by the user. Further, with use of Human cells proceeding into Translational and Clinical Research, there is a need for IS09000 and cGMP level equipment and procedures, which this invention would well serve.

### SUMMARY OF THE INVENTION

The present invention pertains to cell and tissue culture scraping devices that meet the needs in the field by providing a multi-piece cell scraping device that includes a portion that may be reusable and grasped by the user (e.g., a handle), and a scraping tip that may be fitted into the handle and discarded as necessary. Thus, a preferred device of the invention may include a two-piece system that features a straight stick like tool terminated at one end with a tapered end which fits into a hole or aperture of a reusable handle with a second termination that features, for example, a 6 mm blade of several designs.

In one aspect, the present invention pertains to a scraping device for interacting with cells or tissues on a surface of a dish. The device may comprise a handle for grasping the device that includes a longitudinal axis. The device may also include a hub disposed on the handle. In certain embodiments, the device may include a cell scraping tip for interacting with cells on the surface of a dish that may be configured to be removably engaged to the hub. The hub may comprise an aperture configured to receive the cell scraping tip in removable engagement with the cell scraping tip having a tip arm that may include an engagement end for removably engaging with the hub and a cell scraper end for interacting with cells on the surface of the dish. Additionally, the aperture disposed on the hub may be configured to receive the cell scraping tip at an angle measured between the longitudinal axis of the handle and the tip arm.

In an alternative aspect of the device of the invention, the present invention includes a one-piece scraping device for interacting with cells or tissues on a surface of a dish. The device may comprise a handle for grasping the device that includes a longitudinal axis. The device may also include a cell scraping tip for interacting with cells on the surface of a dish where the cell scraping tip is permanently engaged to the handle. The cell scraping tip may include a tip arm having a cell scraper end for interacting with cells on the surface of the dish and an attachment end that is fused or permanently engaged to the handle. Moreover, the cell scraping tip may include a cell scraper disposed at one end of the cell scraping tip. The cell scraper may comprise a flared blade, a notched flared blade, a pick, a square blade, a chisel tip, a rake, a fan, or a combination thereof in accordance with the present invention.

In another aspect, the invention may include a method of manufacturing a scraping device for interacting with cells on a surface of a dish, where the scraping device includes a handle and cell scraping tip for interacting with cells on the surface of a dish that may be configured to be removably engaged to the hub. The methods of manufacture may include at least one of 3D-printing, molding, and casting.

Therefore, the present invention provides devices, and methods of manufacturing the same, that allow users to finely manage cell culture assays that may include cells (e.g., stem cells) and tissues while providing users with a reusable device that readily replaces the glass systems known in the art.

### BRIEF DESCRIPTION OF THE DRAWINGS

The foregoing summary and the following detailed description of the exemplary embodiments of the present invention may be further understood when read in conjunction with the appended drawings, in which:

FIGS. 1A to 1F schematically illustrate both assembled (FIG. 1A) and disassembled (FIG. 1B) views of a cell scraping device of the invention; a side view of a reusable handle of a cell scraping device of the invention (FIG. 1C); an X-axis view, Y-axis view, and Z-axis view of a cell scraping tip of the invention (FIG. 1D); an exemplary reusable handle of the invention (FIG. 1E); and an exemplary alternative one-piece cell scraper (FIG. 1F).

FIGS. 2-5 schematically illustrate a variety of cell scraping tip embodiments that may be provided in accordance with the invention, including a notched, flared blade tip (FIG. 2A); a chisel tip (FIG. 3A); a pick tip (FIG. 4A); a fan tip (FIG. 5A); and, additionally, exemplary cell scraping tips in accordance with the invention, such as a notched flared blade tip (FIG. 2B); a chisel tip (FIG. 3B); a pick tip (FIG. 4B); and a fan tip (FIG. 5B).

FIG. 6 schematically illustrates an angle between the longitudinal axis of the handle of the invention and the cell scraping tip. This angle may be modified or adjusted as necessary to provide varied devices of the invention.

FIGS. 7A-7C schematically illustrate cell scraping tips having a curved or offset tip arm (FIG. 7A) for use in certain assays where, for example, the tip arm may be submerged in liquid; an exemplary offset tip (FIG. 7B); and an exemplary curved tip (FIG. 7C). The curve or offset of the tip arm may adjust for the refraction of light, allowing the user to have greater control when adjusting cells at the surface of a medium.

FIG. 8 schematically illustrates a cell scraping tip that includes electrodes for electrically interacting with cells at the surface of a medium.

### DETAILED DESCRIPTION OF THE INVENTION

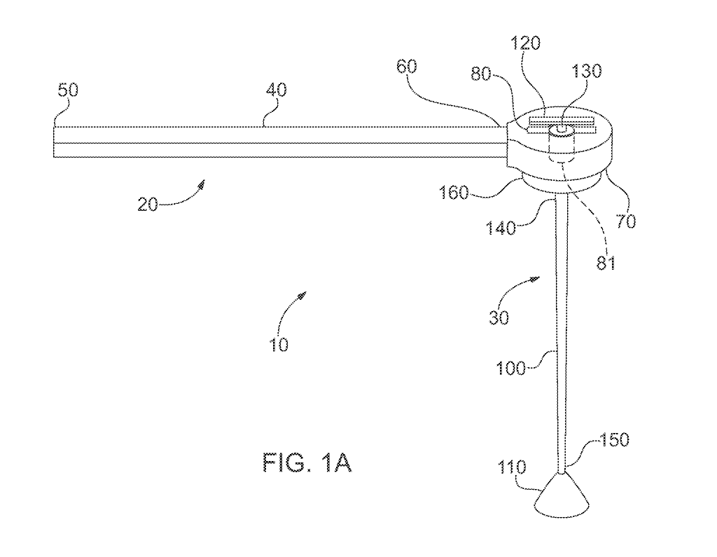

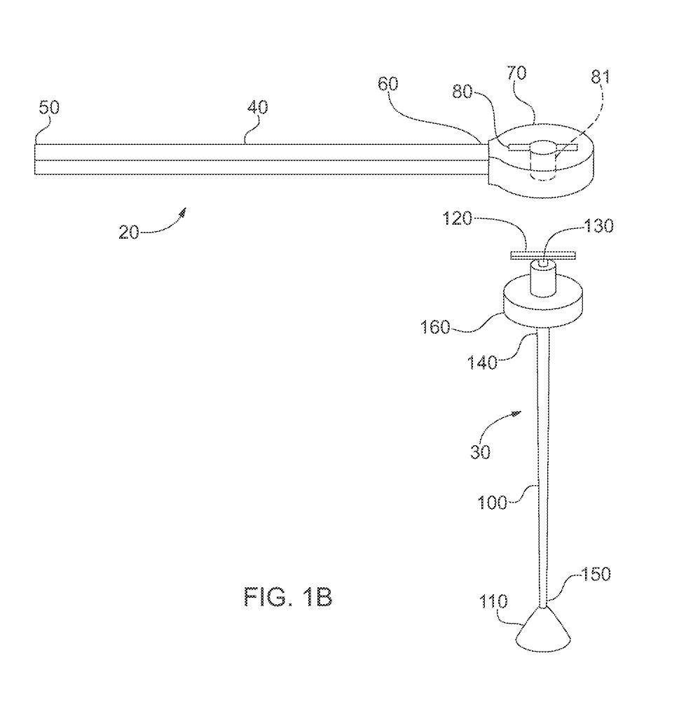

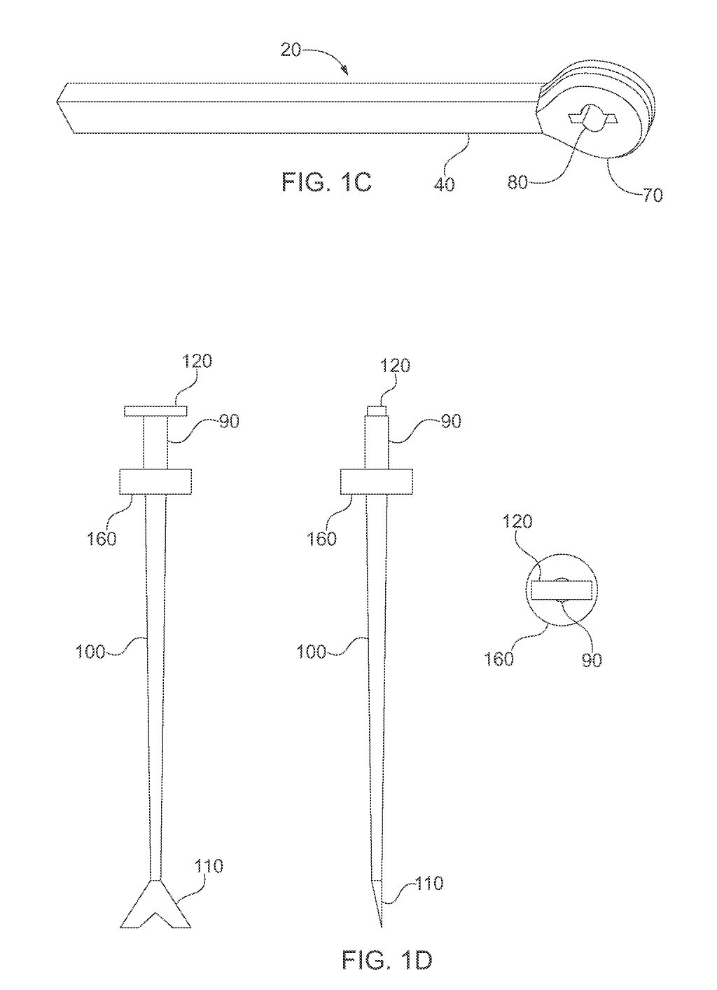

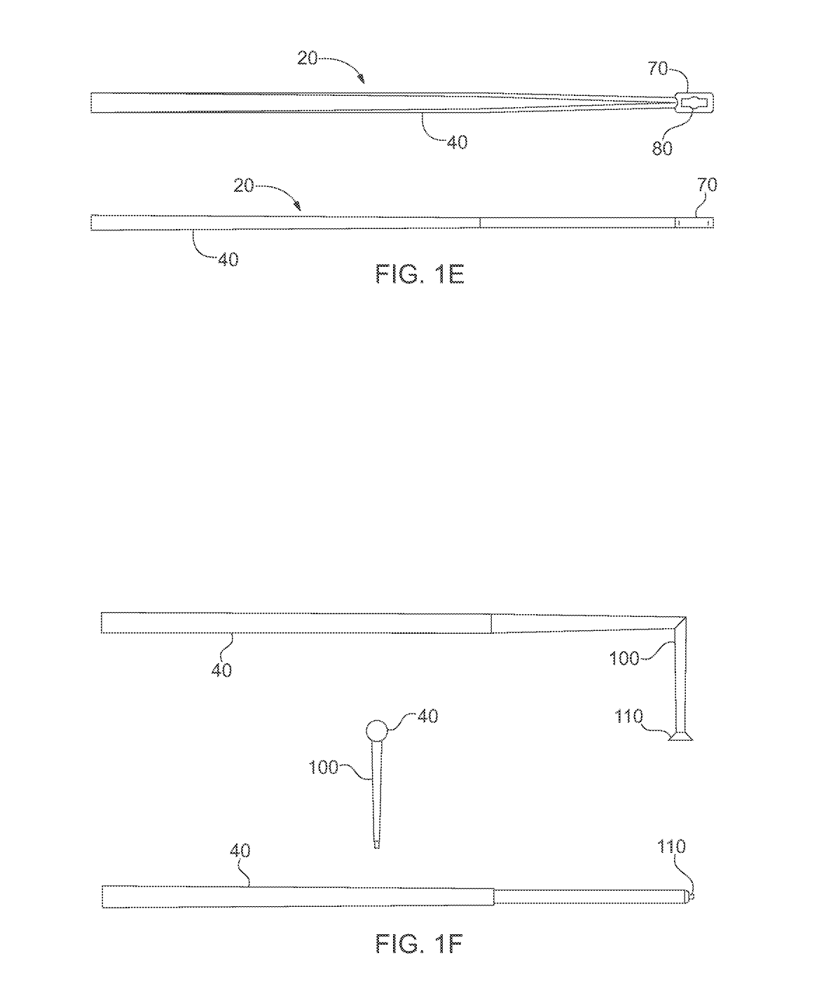

The present invention provides a device that allows a user to manipulate cells, such as Pluripotent Stem Cells (either embryonic, or induced pluripotent), and tissues disposed at the surface of a medium or dish. Referring now to the figures, wherein like elements are numbered alike throughout, an exemplary scraping device 10 that is designed for interacting with cells and tissues is shown in FIGS. 1A to 1D. Specifically, FIG. 1A provides an assembled scraping device 10 with FIG. 1B setting forth a dissembled scraping device 10 of the invention. The scraping device 10 includes a handle portion 20 (see FIG. 1C) and a cell scraping tip portion 30 (see FIG. 1D). The handle portion 20 and/or the cell scraping tip portion 30 may be composed of materials that are reusable or disposable. However, in preferred aspects of the invention, the handle portion 20 is composed of materials that render it reusable. Moreover, in certain aspects of the invention, the cell scraping tip 30 is disposable.

Turning to the handle portion 20 more specifically, the handle portion 20 may have a handle 40 that may include a proximal end 50 and distal end 60. The proximal end 50 may include the end that is grasped by the user. The handle 40 may include knurling to aid the user in gripping the handle 40 and such knurling may extend from the proximal end 50 to the distal end 60 or may only cover a partial portion of the handle 40. The handle 40 may also include a hub 70 that may be disposed along the handle 40, but is preferably disposed at the distal end 60. The handle portion 20 may be less than about 300 mm in length. The handle portion 20 may also be less than about 250 mm in length or, preferably, about 150 to 200 mm in length. An exemplary handle portion 20 of the invention is set forth in FIG. 1E. Accordingly, the hub 70 may be less than, equal to, or wider than the handle 40.

The hub 70 may also be included in a paddle that is disposed at the distal end 60 of the handle 40. Indeed, in certain embodiments of the invention, the hub 70 may be located in the paddle where the paddle is wider than the handle 4 itself, as shown in FIGS. 1A and 1B. However, the paddle portion of the handle 40 does not have to be excessively large when compared to the handle size. Alternatively, the hub 70 may be located in the paddle where such paddle is narrower than the handle 40. The handle 40 may be about 2-20 mm wide or, preferably, about 3-10 mm wide. The hub 70 may be about 2-20 mm wide or, preferably, about 3-10 mm wide.

The hub 70 may also include an aperture 80 that forms a hole in the hub 70 that is designed to allow the tip of the invention to be affixed to the handle portion 20. Specifically, the aperture 80 may receive the cell scraping tip 30 in removable engagement. The aperture 80 may traverse the full width of the paddle or hub 70, providing a channel 81 that extends from one side of the hub 70 to the other as demonstrated in the exemplary embodiment shown in FIGS. 1A and 1B. Alternatively, the channel 81 of the aperture 80 may terminate prematurely and not traverse the full width of the hub 70. In such an instance, the scraping tip 30 may not include either a spacer 130 or a rotator arm 120, but will be terminate with an engagement portion 90 at the attachment end 140. The aperture 80 may be about 1-20 mm wide or, preferably, about 2-10 mm wide.

Furthermore, the aperture 80 of the hub 70 may be provided as a keyhole or shaped channel that may be a substantially cylindrical or conical (or frustoconical) structure, as necessitated for frictional engagement of the cell scraping tip 30. For example, the aperture 80 may include notches as pictured in FIG. 1C. Such notches pictured in the aperture 80 of at least FIG. 1C allow for the passage of objects that are not entirely cylindrical, such as rotator arm 120, which may be in the shape of bar or “T” (see FIG. 1D). The notches of the aperture 80, including a keyhole, may extend the width of the aperture 80, in at least one dimension, an additional 0.1-10 mm

In certain aspects of the invention, the aperture 80 may be prepared such that it may receive a portion of cell scraping tip 30 and removably engage the cell scraping tip 30 by frictional engagement between a surface of the engagement portion 90 and an interior surface of the aperture 80. The cell scraping tip 30 may include an attachment end 140 and cell scraping end 150, where the attachment end 140 and cell scraping end 150 are bridged by a tip arm 100. Moreover, the cell scraping tip 30 may be less than about 100 mm in length or, preferably, about 10-100 mm in length. Particularly, the cell scraping tip 30 may be about 30-75 mm in length.

As shown in FIG. 1D, the cell scraping tip 30 may include the engagement portion 90 at attachment end 140 for engagement between the handle portion 20 and the cell scraping tip 30. In preferred embodiments, the engagement between the portions of the two-piece invention is achieved by removable frictional engagement where the engagement portion 90 may be placed in the aperture 80 to provide a friction fitting. As used herein, the term “friction fitting” means that the engagement portion 90 is held in place at aperture 80 as a result of its shape or close contact with the aperture 80, but is not bonded to the aperture 80. The engagement portion 90 may be about 1-20 mm in length or, preferably, about 2-10 mm in length.

In alternative embodiments of the invention, the engagement portion 90 of the cell scraping tip 30 may be permanently engaged in the aperture 80 as necessary or desired by the person having ordinary skill in the art. In one alternative embodiment, the device 10 may be prepared as a one-piece instrument where the handle portion 20 is fused or permanently connected to the scraping tip 30, and may thus be fabricated as a single unit. Additionally, the handle portion 20 and the scraping tip 30 may be fabricated from a single polymeric material as a unit. In accordance with such a one-piece scraping device for interacting with cells or tissues, the device may include a handle 40 that is permanently engaged, or fused, to the attachment end 140 of the cell scraping tip 30. In the one piece embodiment, the handle portion 20 may be less than about 300 mm in length. The handle portion may be less than about 250 mm in length or, preferably, about 150 to 200 mm in length.

Moreover, the cell scraping tip 30 in the one piece embodiment may be less than about 100 mm in length or, preferably, about 10-100 mm in length. Particularly, the cells scraping tip 30 may be about 30-75 mm in length. An exemplary one-piece cell scraper of the invention is set forth in FIG. 1F.

Regarding shapes that may be utilized to provide the friction fitting of the invention, the engagement portion 90 and aperture 80 may be provided as conical frustrums, cylinders, or combinations thereof, provided that the insertion of the engagement portion 90 into the aperture 80 provides a friction fitting that allows the pieces of the invention to be held in place during use as disclosed herein. Indeed, the engagement portion 90 may be tapered while the aperture 80 is also tapered to substantially match the engagement portion 90. In other embodiments, the aperture 80 and/or the engagement portion 90 may be composed of materials that are deformable or, by contrast, resilient as necessary to insure the appropriate frictional fit between the parts.

The engagement portion 90 may include a rotator arm 120 that may be affixed or otherwise attached to the top of the engagement portion 90. Upon the insertion of the engagement portion 90 into the aperture 80, the rotator arm may pass through the aperture 80 such that upon frictional engagement between the engagement portion 90 and the aperture 80, or immediately before, the user may grasp the rotator arm 120 and rotate the cell scraper tip 30. The rotator arm 120 may be fabricated into any shape that allows for the user to freely move, rotate and/or adjust the attitude of the cell scraping tip 30. In certain embodiments, the rotator arm 120 may be in the form of a bar or “T” shape as provided in FIGS. 1A, 1B, and 1D. In addition, the rotator arm 120 may be directly affixed to the engagement portion 90 or may be attached thereto with a spacer 130 as necessary or desired. Accordingly, the engagement portion 90 may be substantially cylindrical, conical, or frustoconical, for example. The engagement portion 90 may also be narrower than the aperture 80 and channel 81. However, in such instances, the engagement portion may include extensions that extend outwardly from the engagement portion 90 and allow for frictional engagement with the channel 81 thereby providing a friction fitting. The extensions may be fins and may or may not be tapered. The rotator arm 120 may about 1-20 mm wide or, preferably about 2-10 mm wide.

Additionally, a stop 160 may be provided on the cell scraping tip 30 in order to prevent the cell scraping tip 30 from passing through the aperture 80 or, in other embodiments, allow the cell scraping tip 30 to be placed in a box made for pipette tips. The tip head may be designed to fit in a rack fabricated for, or having the same specifications of, common pipette tips used in the field. The stop 160 may be disposed on the cell scraping tip 30 between the engagement end 140 and the cell scraping end 150. Preferably, the stop 160 is disposed in close proximity to or at the engagement end 140. The stop 160 may be a protrusion, a shaped plate, or a combination thereof. Protrusions of the invention may be bumps, knobs, or notches that will catch an edge of the aperture 80 or the lip of a container to prevent the cell scraping tip from passing therethrough. Alternatively, or, possibly in addition thereto, the stop 160 may be a shaped plate, such as a circular plate, a triangular plate, a square plate, a pentagonal plate, a hexagonal plate, a heptagonal plate, an octagonal plate, or a combination thereof. For example, there may be provided a ring of similar diameter so that the scraper can be racked into currently available boxes. Accordingly, in one preferred embodiment the stop 160 may take the form of a circular ring that is placed at the engagement end 140. In certain aspects the stop 160 may be a ring or plate positioned such that the engagement end 140 projects from the center of the ring or plate 160 or, alternatively, the engagement end 140 may project off-center of the ring or plate 160. For example, where the stop 160 is a circular ring, as shown in FIG. 1D, the engagement end 140 may be positioned at the edge of the circular ring rather than at the center. The stop 160 may be about 0.1-30 mm wide or, preferably, about 1-20 mm wide.

At the cell scraping end 150, there may be provided a cell scraper 110 for moving, cultivating, modifying, or otherwise adjusting cells or tissues on a plate. A cell scraper 110 of the invention may include any tip that allows for adjustment of cells or tissues on a millimeter or sub-millimeter scale, as would be understood by ordinary artisan.

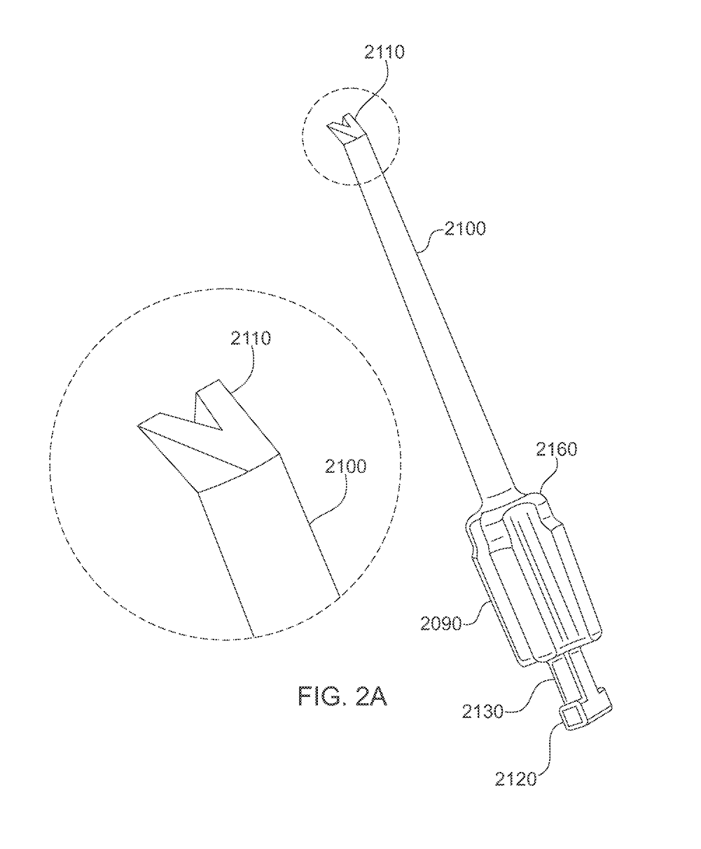

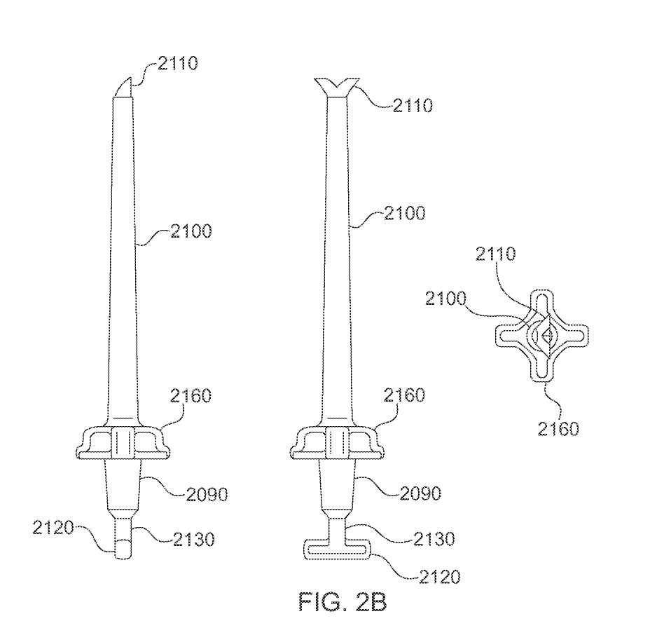

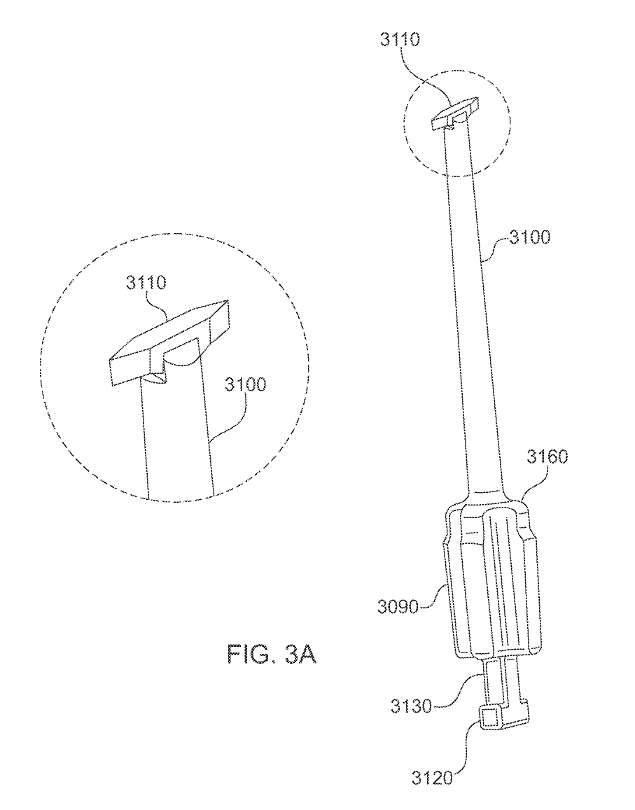

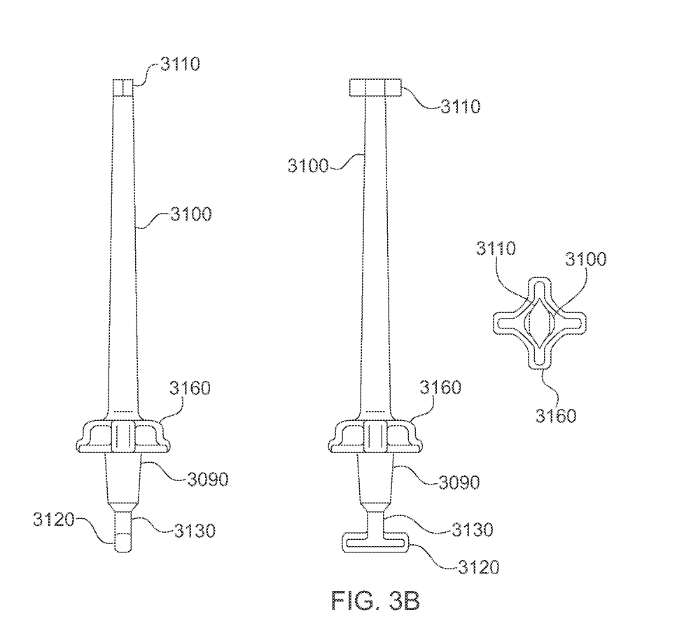

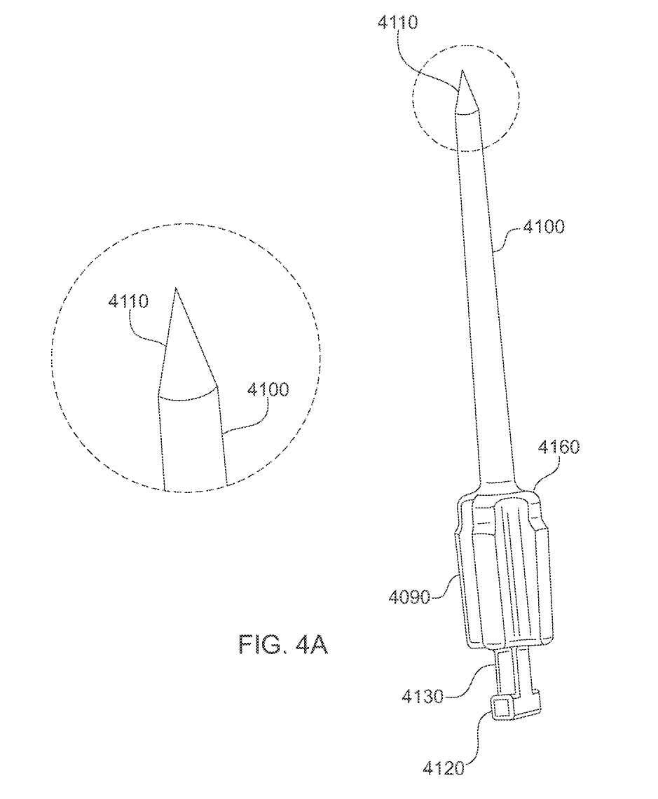

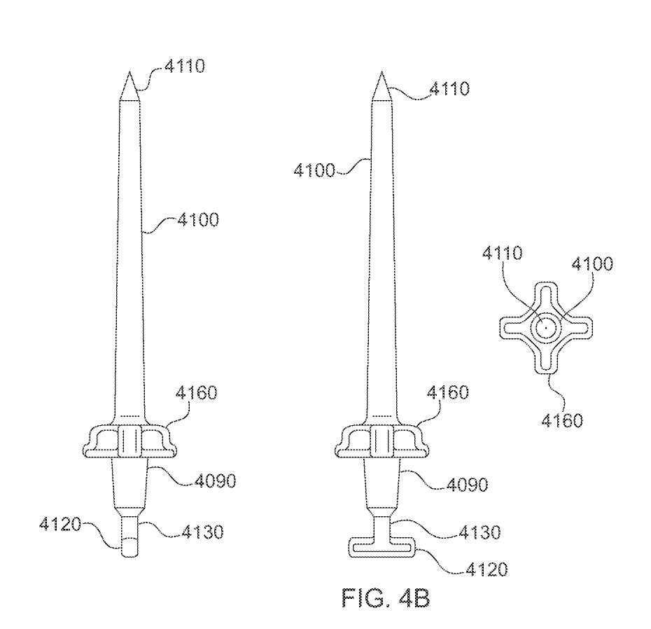

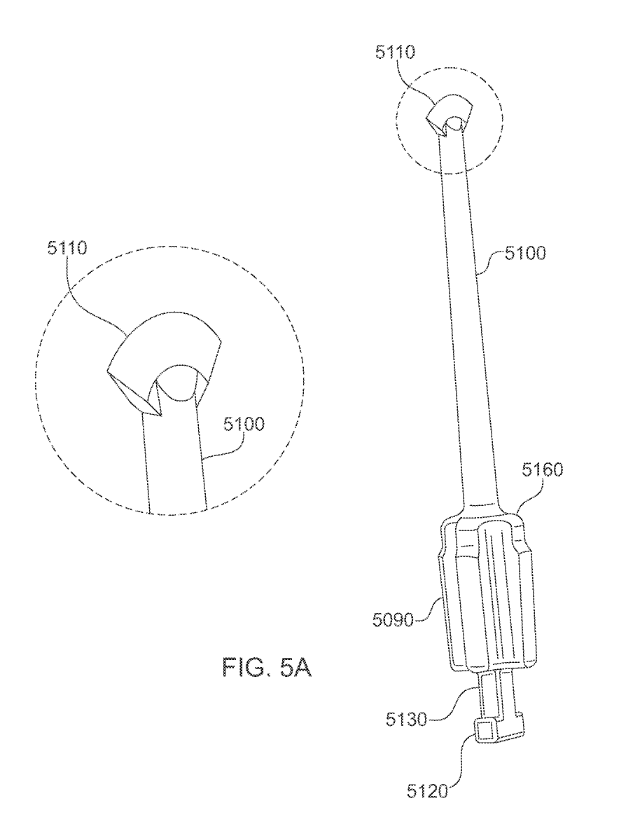

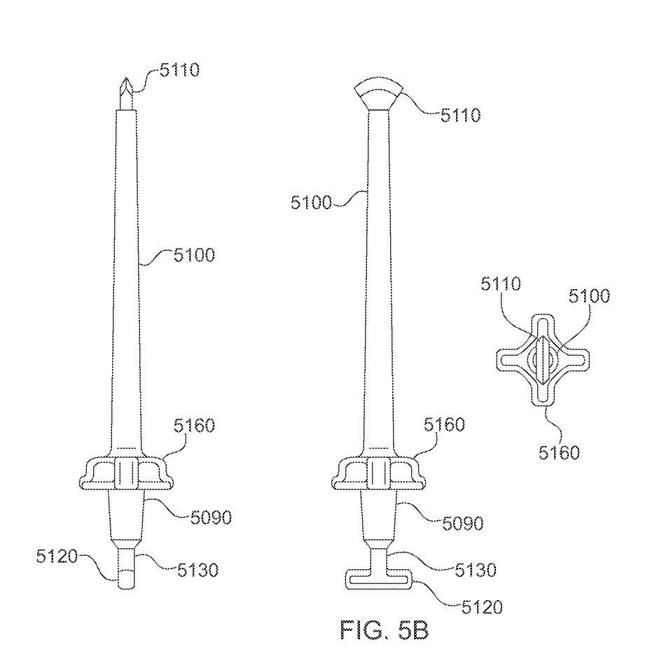

The cell scraper 110 may include a variety of shapes, such as a flared blade, a notched flared blade, a pick, a square blade, a chisel tip, a rake, a fan, or a combination thereof. In particular embodiments, the cell scraper 110 may be a notched flared blade as shown in FIG. 2A, a chisel tip as shown in FIG. 3A, a pick as shown in FIG. 4A, or a fan as shown in FIG. 5A. Regarding the cell scraper tips illustrated in FIGS. 2A-5A, each of the cell scraping tips include a rotator arm 2120, 3120, 4120, and 5120, respectively; a spacer 2130, 3130, 4130, and 5130, respectively; an engagement portion 2090, 3090, 4090, and 5090, respectively; a stop 2160, 3160, 4160, and 5160, respectively; and a tip arm 2100, 3100, 4100, and 5100, respectively. In the embodiments provided in FIGS. 2A-5A, the rotator arm 2120, 3120, 4120, 5120 is a bar connected to the engagement portion 2090, 3090, 4090, 5090 via a spacer 2130, 3130, 4130, 5130 (e.g., a rectangular spacer is shown in FIGS. 2A-5A). At one end of the engagement portion 2090, 3090, 4090, 5090 (which may include tapered fins for frictional fitting with a channel, such as channel 81 in FIG. 1, as shown in FIGS. 2A-5A), is a stop 2160, 3160, 4160, 5160 that is a protrusion that is wider than tip arm 2100, 3100, 4100, 5100. Accordingly, each of the cell scrapers illustrated in FIGS. 2A-5A, includes a tapered tip arm 2100, 3100, 4100, and 5100 that terminates in cell scrapers 2110, 3110, 4110, 5110. More specifically, the cell scrapers illustrated in FIGS. 2A-5A include a notched flared blade 2110 (FIG. 2A), a chisel tip 3110 (FIG. 3A), a pick tip 4110 (FIG. 4A), and a fan tip 5110 (FIG. 5A). Moreover, additional exemplary cell scrapers of the invention are set forth, respectively, in FIGS. 2B-5B where such exemplary cell scrapers include engagement portions 2090, 3090, 4090, and 5090, respectively, that are frustoconical.

The cell scraper 110 of the invention may be less than 10 mm wide. Preferably, the cell scraper 110 may be about 0.1 to 20 mm wide. In certain aspects, the cell scraper 110 may be about 1-10 mm wide or, preferably, about 2-8 mm wide. Where the cell scraper 110 includes a notch, the notch may be less than about 5 mm wide or, preferably, about 1-2 mm wide. Moreover, the cell scraper 110 of the invention may be less than about 10 mm long, or, preferably, about 1-5 mm long. At the foregoing sizes, the device occupies almost the entire microscopic field using a standard inverted cell culture microscope together with a 4× objective and 10× eye piece. In a particular aspect, where the cell scraper is a flared blade or notched flared blade (i.e., notched flared blade 2110), such blades may be about 6 mm wide.

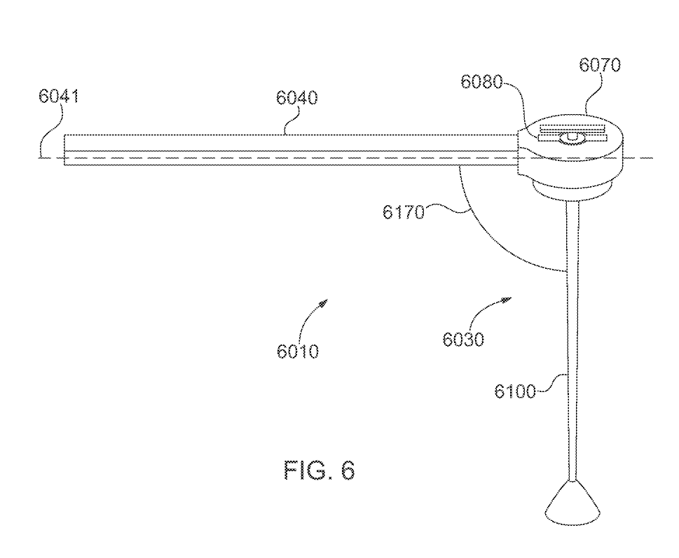

The position of the cell scraper tip 30 with respect to the handle portion 20 may also be adjusted or modified as necessary or required by the ordinary artisan. As shown in FIG. 6, the hub 6070 (the hub being substantially the same as hub 70 in FIG. 1) may be configured to allow the aperture 6080 to be positioned at an angle 6017, which is measured between a longitudinal axis 6041 that extends through the handle 6040 in FIG. 6 and the tip arm 6100. The angle 6017 may be less than about 180°. In certain embodiments, the angle 6017 is less than about 90°. Preferably, the angle 6017 is about 90°. This is particularly important to avoid interfering with light originating from above as with a standard inverted cell culture microscope, and possibly interfering with the material-cell culture media interface thus causing a disturbance in the light either from above or below as with a fluorescence based imaging technique. In addition, where the cell scraper tip 30 and the handle portion 20 are permanently fused together, such as in a one-piece device, the angle between the cell scraper tip 30 and the handle portion 20 may be adjusted during the manufacture of the device to provide a fixed angle between the cell scraper tip 30 and handle portion 20 that may be less than about 180°, or less than about 90°, or, in preferred aspects of the one-piece device of the invention, about 90°.

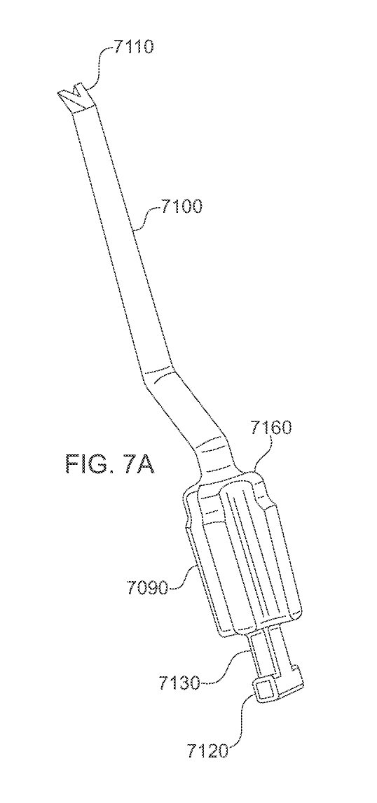

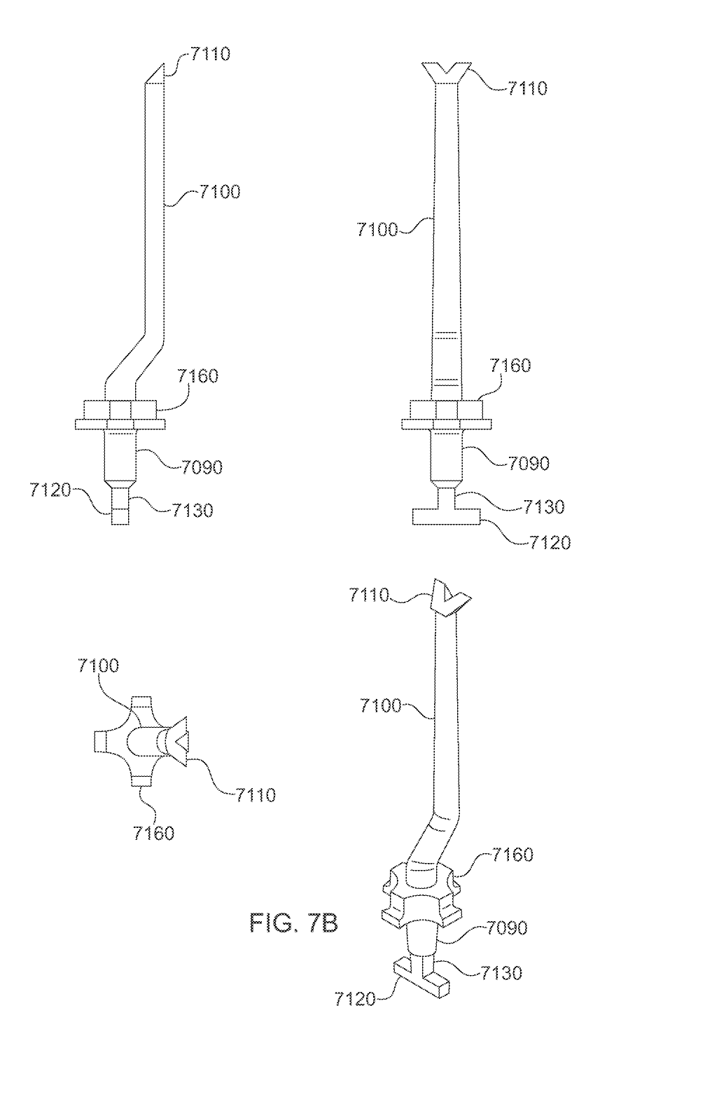

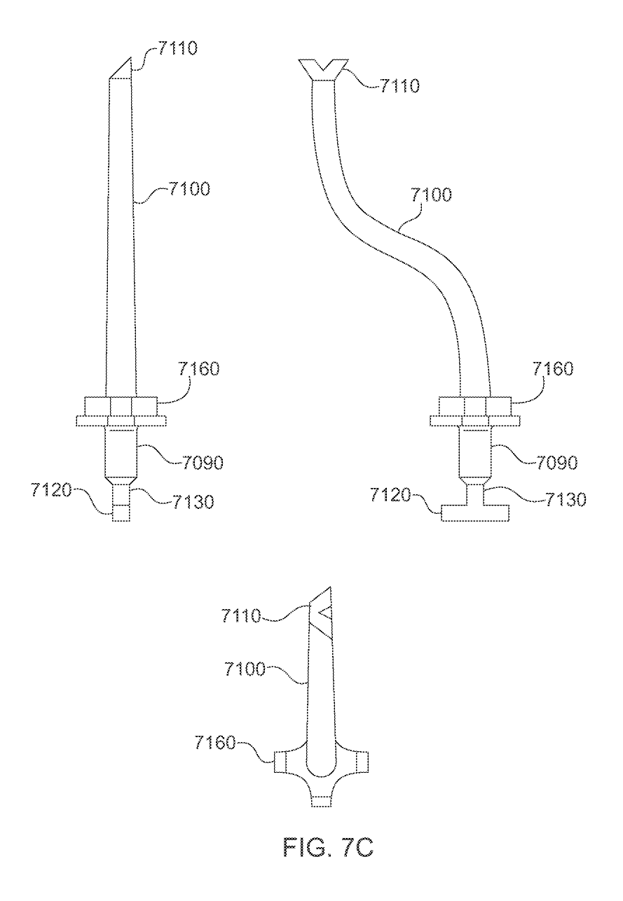

In certain aspects of the invention, the handle 40 and/or the tip arm 100 may be tapered or straight. Alternatively, the handle 40 and/or the tip arm 100 may also be curved or offset, and may or may not be flexible. Referring to FIG. 7A, one embodiment of the invention includes a cell scraping tip having a rotator arm 7120 that is a bar connected to the engagement portion 7090 via a rectangular spacer 7130. At one end of the engagement portion 7090 (which may include tapered fins for frictional fitting with a channel, such as channel 81 in FIG. 1, as shown in FIG. 7A) is a stop 7160 that is a protrusion that is wider than tip arm 7100. As further illustrated in FIG. 7A, the tip arm 7100 is a curved tip arm terminating in a notched flared blade tip 7110. Curving the tip arm 7100 allows the user to adjust for the refraction of light when adjusting cells at the surface of a medium that is submerged in a solution. An exemplary offset cell scraping tip is set forth in FIG. 7B, and an exemplary curved cell scraping tip is set forth in FIG. 7C. Furthermore, the exemplary embodiments shown in FIGS. 7B and 7C include an engagement portion 7090 that is frustoconical.

Turning to the materials utilized in preparing the devices of the invention, such as the exemplary device in FIG. 1, the handle portion 20 and the cell scraping tip 30 may be composed of the same or different materials. Preferably, the handle portion 20 and the cell scraping tip 30 are composed of one or more polymeric materials. For example, the handle portion 20 is preferably reusable and may be composed of a material configured to withstand repeated autoclaving. Indeed, the handle portion 20 may be made solid, and of an appropriate material, allowing it to withstand repeated autoclaving at, for example, 121° C. at 15 psi for 15 minutes.

Moreover, portions of the cell scraping tip 30 may be rigid or flexible as required by the person having ordinary skill in the art. In certain embodiments, the cell scraping tip 30 is composed of materials that render it flexible and spongy. However, the tip arm 100 and the cell scraper 110, for example, may be rigid or flexible.

The handle portion 20 and the cell scraping tip 30 may be composed of polymeric materials such as thermoplastics. For instance, either the handle portion 20 or the cell scraping tip 30 may be composed, independently, from acrylic, nylon, polyethylene, polypropylene, polyvinylchloride, polytetrafluroethylene (PTFE), acrylonitrile butadiene styrene (ABS), t-glase, or a combination thereof.

In a particular embodiment, the handle 40 of the invention my prepared from nylon or ABS. Additionally, the cell scraping tip 30 may be prepared from t-glase, or other transparent polymers. In certain embodiments, the cell scraper 110 is prepared from t-glase or an optically clear material. T-glase is considered colorless per industrial classifications and is also water clear. Moreover, t-glase possesses high tensile strength, is autoclavable, FDA approved, and is 100% reclaimable rendering it an environmentally sound material for fabricating a disposable article such as, for example, the cell scraping tip 30. Moreover, t-glase exhibits very low shrinkage, which simplifies the making of large flat surfaces.

In alternative embodiments of the invention, the cell scraping tip 30 may be prepared as a hollow, rather than a solid tip. In such instances, the tip 30 may have a fluid source affixed to the engagement end 140 and a fluid (e.g., air, water) may be provided through the tip 30 to a plate or other experiment. Moreover, the cell scraping tip 30 may be substantially or completely composed of an optically conductive material such that some form of light, such as a normal light, high intensity LED source, or even laser light can be directed through the cell scraper tip 30. This is particularly useful to activate cellular processes in the field of optogenetics.

Where the device of the invention is utilized during fluorescence assays, such a device 10 of the invention may have a handle portion 20 and/or cell scraping tip 30 that is composed of such materials that are black, such as black polymers, that prevent interference with the wavelengths of light utilized during fluorescence assays.

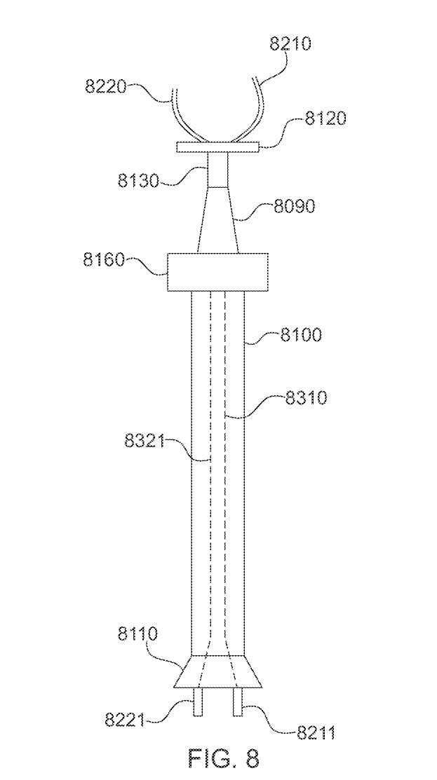

The cell scraping tip 30 may also be developed to have an electrical circuit integrated into the design rendering the cell scraper 110 as a conductor, allowing the device 10 to conduct an electric current through the tip 30 to a plate or other experiment. A conductive tip in accordance with the invention is illustrated in FIG. 8. Similar to the foregoing structures, the exemplary conductive cell scraping tip in FIG. 8 may include a rotator arm 8120, a spacer 8130, an engagement portion 8090 that may be, as demonstrated, a frustoconical engagement portion for frictional fitting with a channel, such as channel 81 in FIG. 1. Moreover, the tip includes a stop 8160 and tip arm 8100 (that may or may not be tapered) that terminates in a cell scraper 8110 (e.g., a flared blade cell scraper). In addition, the conductive tip also includes terminals 8211, 8221 (terminals 8211 and 8221 may be positive and negative terminals, respectively) that project from the cell scraper 8110 for electrically interacting with, and applying an electrical current to, cells and/or tissues in a dish or medium. Attached to terminals 8211 and 8221 may be leads 8310 and 8320, respectively, that extend through the cell scraper 8110 and tip arm 8100 and may erupt from the rotator arm 8120 (as illustrated in FIG. 8), the stop 8160, the tip arm 8100, or the spacer 8130, as connections 8210 and 8220, respectively. These connections 8210 and 8220 may then be connected to a power source or other device as known in the art for generating a voltage and/or a device that measures at least one of current, resistance and voltage. The device illustrated in FIG. 8 may also include a controller connected to a power source for controlling the voltage applied to cells and tissues. The terminals 8211, 8221; leads 8310, 8320; and connections 8210, 8220 may, independently, be composed of a conducting metal or a conductive polymer. For example, terminals, leads, and connections of the invention may comprise a metal selected from the group consisting of gold, silver, and combinations thereof.

Furthermore, the terminals, leads, and connections of the invention may comprise a conducting polymer, such as a poly(pyrrole), polyaniline, and the like. In an alternative embodiment, the device of FIG. 8 may include only one terminal, lead, and connection rather than two. Indeed, where the device includes only one terminal, the cells and or tissues on a dish may act to complete a circuit as necessary or required by a particular assay. Furthermore, in certain other embodiments, a circuit board or other electrical device may be placed in the interior of one of the tip arm 8100, stop 8160, engagement portion 8090, spacer 8130, or rotator arm 8120, and the leads 8310 and 8320 may be connected to such a circuit board or other electrical device. Moreover, where the device of FIG. 8 includes such a circuit board or other electrical device within its structure, the connections 8210 and 8220 may be connected to the circuit board or other electrical device, allowing the user to receive or transmit electrical information through the circuit board or other electrical device.

In other aspects of the invention, the devices 10 of the invention, or individual components thereof (e.g., the handle portion 20 or cell scraping tip 30) may be fabricated via a process of 3D-printing utilizing a 3D-printer and appropriate polymeric materials, as set forth above. When devices of the invention are prepared from 3D-printing, such devices may be fabricated using two print heads. Alternatively, the individual components of the invention may be prepared from polymer casting and/or molding (e.g., injection molding).

In view of the foregoing, the present invention provides cell scraping devices that allow a user to move, adjust, remove, or otherwise handle cells, such as stem cells, and tissues on a millimeter or sub-millimeter scale. Moreover, the devices of the invention provide a two-piece system having a handle that may be reusable with cell scraping tips 30 that may be disposable and mass fabricated. Therefore, the laboratory technician in the field may be provided with a device of the invention for handling cells rather than devices in the art, such as bent glass pipettes, that are fragile, dangerous to fabricate, and possess non-standardized shapes and geometries. Accordingly, the present invention meets a need in the field for a cell scraping device that allows scientists, such as stem cell culture scientists, to pick cells from heterogeneous mixtures without resorting to inaccurate Pasteur pipettes.

A number of patent and non-patent publications may be cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of” when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All devices, materials, and methods described herein that embody the present invention can, in alternate embodiments, be more specifically defined by any of the transitional terms “comprising,” “consisting essentially of,” and “consisting of.”

What is claimed is:

1. A scraping device for interacting with cells on a surface of a dish, comprising:
a. a reusable handle for grasping the device comprising a longitudinal axis;
b. a hub disposed on the handle and comprising an aperture; and
c. a cell scraping tip for interacting with cells on the surface of a dish comprising a tip arm having an engagement end for removably engaging with the hub and a cell scraper end for interacting with cells on the surface of a dish, the cell scraping tip configured to be removably engaged to the hub at the aperture;
wherein the aperture is configured to receive the cell scraping tip at an angle measured between the longitudinal axis and the tip arm.

2. The device of claim 1, wherein the handle comprises a proximal end and a distal end with the hub being disposed at the distal end of the handle.

3. The device of claim 1, wherein the aperture comprises a keyhole.

4. The device of claim 1, wherein the aperture is configured to removably engage the cell scraping tip by frictional engagement between a surface of the engagement end and a surface of the aperture.

5. The device of claim 1, wherein the engagement end is tapered.

6. The device of claim 1, wherein the cell scraping tip comprises a rotator arm for rotating and adjusting the cell scraping tip.

7. The device of claim 6, wherein the rotator arm is disposed at the engagement end.

8. The device of claim 6, wherein the aperture comprises cutouts to accommodate the rotator arm when removably engaging the hub and the engagement end.

9. The device of claim 6, wherein the rotator arm is a t-shaped rotator arm.

10. The device of claim 1, wherein the cell scraping tip comprises a stop.

11. The device of claim 10, wherein the stop is disposed between the engagement end and the cell scraper end.

12. The device of claim 11, wherein the stop comprises at least one of a protrusion and a shaped plate.

13. The device of claim 1, wherein the tip arm is tapered.

14. The device of claim 1, wherein the cell scraper end comprises a pick, a square blade, a flared blade, a notched flared blade, a rake, a fan, a chisel or a combination thereof.

15. The device of claim 1, wherein the cell scraper end is rigid or flexible.

16. The device of claim 1, wherein the handle comprises a knurled portion.

17. The device of claim 1, wherein the angle measured between the longitudinal axis and the tip arm is less than about 180°.

18. The device of claim 1, wherein the angle measured between the longitudinal axis and the tip arm is less than about 90°.

19. The device of claim 1, wherein the angle measured between the longitudinal axis and the tip arm is 90°.

20. The device of claim 1, wherein at least one of the handle and the cell scraping tip comprise a polymeric material.

21. The device of claim 1, wherein the handle comprises a thermoplastic polymer.

22. The device of claim 21, wherein the thermoplastic polymer comprises t-glase, acrylic, nylon, polyethylene, polypropylene, polyvinyl chloride, polytetrafluoroethylene (PTFE), acrylonitrile butadiene styrene (ABS), or a combination thereof.

23. The device of claim 1, wherein the cell scraping tip comprises a thermoplastic polymer.

24. The device of claim 23, wherein the thermoplastic polymer comprises t-glase, acrylic, nylon, polyethylene, polypropylene, polyvinyl chloride, polytetrafluoroethylene (PTFE), acrylonitrile butadiene styrene (ABS), or a combination thereof.

25. The device of claim 1, wherein the handle comprises a first polymeric material and the cell scraping tip comprises a second polymeric material that is different from the first polymeric material.

26. The device of claim 1, wherein the handle comprises nylon.

27. The device of claim 1, wherein the cell scraping tip comprises t-glase.

28. The device of claim 1, wherein the cell scraping tip comprises an optically clear material.

29. The device of claim 1, wherein the cell scraping tip is configured to conduct an electric current.

30. The device of claim 1, wherein the cell scraping tip is hollow and is configured to transmit a stream of fluid.

31. The device of claim 30, wherein the fluid comprises air.

32. The device of claim 1, wherein the cell scraping tip comprises at least one of a curved portion and an offset portion.

33. A method of manufacturing a scraping device for interacting with cells on a surface of a dish, having a handle and a cell scraping tip according to claim 1, comprising at least one of a 3D-printing step, a molding step, and a casting step.
